(19) United States
(12) Patent Application Publication
(10) Pub. No.: US 2016/0215924 A1
(43) Pub. Date: Jul. 28, 2016

(54) BRACKET

(71) Applicant: CSR Building Products Limited, North Ryde (AU)

(72) Inventor: Adrian Puzey, North Ryde (AU)

(21) Appl. No.: 15/008,651

(22) Filed: Jan. 28, 2016

(30) Foreign Application Priority Data
Jan. 28, 2015 (AU) 2015900238

(51) Int. Cl. F16M 13/02; E04H 17/14; E04H 17/24

(52) U.S. Cl. CPC F16M 13/02; E04H 17/24; E04H 17/14; E04H 2017/1447

(57) ABSTRACT

A building system for building structures, such as a barrier in the form of a fence, includes a connector in the form of a bracket for joining panels to uprights. The bracket includes a loop portion for attaching the bracket to the upright of the fence and a retaining portion for receiving an edge or corner of the panel to secure the panel to the upright. One form of the bracket has the loop portion in alignment with the retaining portion whereas another form of the bracket has the loop portion in stepped relationship with the retaining portion. The two forms of the bracket are complementary to each other and each bracket can be used in different orientations.

### FIELD

The present invention relates to a connector for joining a first building component to a second building component, and to methods of using such connectors to join the two building components to each other.

In one form, the present invention relates to a connector in the form of a bracket for joining two different building components to one another in which one of the building components is a support member for supporting the other of the building components which is a cover member.

In one form, the present invention relates to a connector in the form of a bracket or similar that is able to adopt different orientations with respect to the support member to join the cover member to the support member for forming a building structure having diverse configurations.

The present invention finds particular application as a versatile bracket that can be used in different orientations to connect respective barrier members to respective support members during construction of the building structure in the form of a fence.

Although embodiments of the bracket for joining different building components to one another will be described, it is to be noted that the scope of protection is not restricted to the described embodiments, but rather the scope of protection is more extensive so as to include other forms and arrangements of the brackets for joining a range of different building components to one another for a variety of different purposes and uses other than in the construction of the building structure specifically described.

### BACKGROUND

Building structures are made from a range of different types and forms of building components which require joining together by the use of connectors including specialised connectors having a single dedicated function to form the required type of building structures. One example of a building structure is a barrier.

Forms of the barriers have a first type of building component being supporting members for providing strength and support to the structure and a second type of building component being covering members, such as infill members, for forming solid surfaces preventing movement past or through the barriers. An example of a barrier is a fence, particularly a solid fence. Although the present invention will be described with reference to a fence, it is to be noted that the scope of protection is not restricted to fences, but rather reference to a fence is for ease of understanding and clarify of expression and is not to be limiting.

In the past, some types of fences have been available in prefabricated form made from a variety of different factory made or factory produced components which needed to be joined together to form the fence, such as a range of different connectors for connecting the major components of the fence together, including both structural components, such as uprights, and decorative components, such as facades and the like. Of necessity, owing to the diversity and variability of the types or styles of fences and the locations in which the fences are to be built, a range of different connectors were required in order to construct the fence in which almost all of the connectors are dedicated connectors having a single purpose or function or application only, such as joining one type of building component to another type of building component in one way only. Having to stock and/or use a range of dedicated single function connectors required a large inventory of differently shaped, styled or sized connectors to be available on site to accommodate all of the different possible combinations of joining the various building components together encountered when constructing the fence. In such systems, if a particular connector that was required to join two different individual building components was not available, the construction of the fence was delayed until the correct connector could be sourced for use to progress building of the fence. The unavailability of the required dedicated connector increased the time taken to construct the fence, and hence its cost. Accordingly, there is a need to reduce the number of different connectors that are required to build a fence by providing connectors which are more versatile so that they can be used for more than a single dedicated purpose in a range of different situations to complete the construction of the fence or similar building structure, so that a reduced inventory of a lesser number of connectors only is required to be available on site.

One problem of having to use a range of differently shaped and styled connectors, each having a single function only, is that the selection of the correct connector for a particular circumstance is sometimes difficult for the person constructing the fence, particularly if the person is a home handyman or do-it-yourself enthusiast who is not experienced and/or knowledgeable about the precise function of the dedicated connector and where and when it is to be used, and to know which of the multiple connectors to use for a given combination of building components.

This uncertainty in selection of the critical connectors of the fence leads to frustration and delays, as well as to the use of incorrect fittings and connectors to construct the fence with the possible outcome of the fence not being constructed in accordance with the specifications of the fence, such as for example, the fence being less robust than required. In some cases, the fence could collapse resulting in injury and damage. In extreme cases, the collapse of fences, such as through having insufficient structural integrity, wind loading, support, or the like, has resulted in death by the fence falling on persons.

Accordingly, there is a need for a more universal connector that can be used in a variety of different circumstances to join different individual components when constructing a fence that simplifies the choice of a suitable connector.

Accordingly, it is an aim of the present invention to provide a connector in the form of a bracket which has more universal application in forming a building structure than existing dedicated connectors.

Accordingly, it is an aim of the present invention to provide a connector in the form of a bracket which is more versatile to use in constructing a barrier in the form of a fence.

Accordingly, it is an aim of the present invention to provide a method of constructing a fence using a pair of connectors in the form of brackets to simplify the construction of the fence.

It is to be noted that not all embodiments will satisfy all aims. Some embodiments will satisfy one aim whilst other embodiments will satisfy other aims. Some embodiments will satisfy two or more aims.

### SUMMARY

According to one form of the present invention, there is provided a connector for use in connecting a first building member to a second building member to form a building structure, the connector comprising a first part for engaging with the first building member to locate the connector in use with respect to the first building member, the first part having an extension in a first direction, and a second part for retaining the second building member in position with respect to the first building member, wherein the second part of the connector has a first portion and a second portion, the first and second portions being arranged with respect to each other such that the first portion extends in the direction of extension of the first part to be in alignment with the first part extension, the first portion for locating the connector with respect to the second building member, and the second portion of the second part of the connector extending out of alignment with the first part for retaining the second building member in position with respect to the first building member, so that at least one axis of the second building member extends in alignment with at least one axis of the first building member, wherein the first and second building members are connected together by the connector in use of the connector.

According to one form of the present invention, there is provided a connector for connecting a first building member to a second building member to form a building structure of the first and second building members, the connector comprising a first part having a first void for receiving a part of the first building member therethrough, the first void being defined at least in part by at least one extension member, the extension member for contacting the first building member in use of the connector when the first building member is received in the void, wherein the first part of the connector is for locating the connector with respect to the first building member, the connector having a second part for retaining the second building member in position with respect to the first building member to form a part of the building structure, the second part having a holder for retaining the second building member therein to retain the second building member with respect to the first building member for forming part of the building structure.

According to one form of the present invention, there is provided a connector for connecting an elongate member to a substantially planar member to form a building structure containing both the elongate and planar members, the connector comprising a first part having a first generally U-shaped wall defining a void for receiving the elongate member to position the connector with respect to the elongate member, and a second part having a second generally U-shaped wall defining a second void for receiving therein the planar member to locate the planar member with respect to the elongate member, wherein the central axis of the first void is aligned along the central axis of the elongate member and the longitudinal axis of the second void is aligned along the longitudinal axis of the planar member and wherein the central axis of the first void is substantially normal to the longitudinal axis of the second void.

According to one form of the present invention, there is provided a first bracket and a second bracket forming a pair of brackets for joining building panels to respective support posts to form a fence, each of the first and second brackets having a loop portion for receiving therethrough a respective post for locating the bracket at a selected position on the post, and each of the first and second brackets having a panel receiving portion for receiving part of a panel to connect the panel to the post, wherein the loop portion of one of the pair of brackets extends from the receiving portion at a first orientation, such that the receiving portion and loop portion are in stepped relationship with each other, and wherein the loop portion of the other of the pair of brackets extends from the receiving portion at a second orientation such that the receiving portion and loop portion are substantially in alignment with each other and wherein the loop portions of the two brackets are complementary to each other.

According to one form of the present invention, there is provided a system for forming a structure containing a first member and a second member connected together by a connector for connecting the second member to the first member wherein, the connector has a first part for engaging the first member to locate the connector with respect to the first member, and a second part for retaining the second member with respect to the first member, wherein a first connector interconnects a first portion of the second member to the first member and a second connector interconnects a second portion of the second member to the first member to retain the second member interconnected to the second member in the structure such that the first and second connectors are located at spaced apart locations on the first member.

According to one form of the present invention, there is provided a method of forming a structure having a first member and a second member interconnected together by a connector, the method comprising the steps of installing the first member, attaching the first part of the connector to the first member, orienting the connector so that the second part of the connector is oriented to receive the second member, locating the second member within the second part of the connector, wherein the longitudinal axis of the second member extends transversely to the longitudinal axis of the first member.

### BRIEF DESCRIPTION

Typically, the connector used in the method of forming the building structure is a connector according to the immediately preceding paragraphs.

One form of the connector is a bracket, a cleat, a joiner, a coupler, a coupling or similar. Typically, the bracket can take one of a number of different forms, such as for example, the bracket can be in one of two or more forms, such as for example, one of a pair of forms of the bracket, more typically, in one of two forms that are complementary to each other.

Forms of the bracket include a pair of cooperating or complementary brackets that have common cooperating parts, as well as individual different parts.

Forms of the brackets have a first part, for example, an outwardly extending extension, and a second part, for example, a holding or retaining part, typically a holder or a receiving part for one of the building components, more typically a tray part for supporting one or other building component.

One form of the bracket is a stepped form in which the position of an outwardly extending extension is in stepped relationship with the tray part or main part or remaining part of the bracket, such as the tray of the bracket acting as a holder or receiving part. Another form of the bracket is an aligned form in which the outwardly extending extension is aligned with the tray forming the holder or receiving part.

Forms of the bracket have a first portion for engaging with a first building component. Typically the building component is a support member or element, more typically, an elongate member, such as for example, a tube, rod, shaft, post or similar. In one form, the post is hollow, whereas other forms of the post are solid. Forms of the support member are made from metal, timber, plastics, including recycled materials, such as recycled metals or plastics material, optionally mixed with fresh or virgin raw materials, or combinations of different materials. Some forms of the post are made from a combination of materials or from composite materials, laminated materials or the like. A preferred form of the post is steel, typically corrosion resistant steel, or treated steel, such as coated steel, painted steel, colourbond steel, galvanised steel, zinc alum steel or the like in which the steel has a protective coating, such as a weather resistant coating, a corrosion resistant coating, a corrosion inhibiting coating, or the like.

In one form, the tube is a rectangular or square section tube, including a hollow box tube. Typically, the box tube has a length of up to about 2400 mm or more. Typically, the box tube has a substantially square or rectangular cross-section or shape. In one form the cross-section has dimensions in the range of from about 25 mm to about 150 mm, typically, in the range from about 50 mm to 100 mm, more typically, about 75 mm. In one form the cross-section is square. Preferably, the cross-section is 75 mm×75 mm made from 2.5 SHS -C350 (square hollow section tube). In one form, the length of the tube can be increased, such as for example, by an extension piece or similar. In one form, the extension is a sleeve, collar or the like which fits over the upper end in use of the post to increase the height of the post, and hence the height of the fence.

Forms of the post can have non-rectilinear or non-straight or non-flat side profile, such as by being circular, round, cylindrical, elliptical, or the like, particularly where the fence post interconnects two panels of the fence at an angle other than 90°, such as for example, at an acute angle or an obtuse angle, such as for example, at 30°, 45°, 60°, 120°, 135°, 150° or the like. It is to be noted that circular posts provide greater flexibility of design of the fence by not restricting the fence to being straight or at right angles only. In one form the diameter of the round or cylindrical post is about 75 mm.

In one form, the second building component is an infill panel, facade, covering member or other similar building panel, typically, a lightweight building panel, preferably an autoclaved aerated concrete (AAC) panel, more preferably made by CSR Building Products Limited and marketed under the HEBEL® brand. Specific examples of the panel include an AAC panel available under the name Hebel Power Panel. Optionally the panel is a steel reinforced AAC panel having a reinforcing mesh embedded within the panel.

The size of the panel can be any suitable or convenient size having a length of up to about 2400 mm, more typically, up to about 1800 mm, a width of up to about 900 mm, typically up to about 600 mm, and preferably in the range from about 300 mm to 600 mm, and any suitable thickness from about 50 mm to 300 mm, typically from about 65 mm to 150 mm, preferably about 75 mm. In one form, the thickness of the panel corresponds to the side or wall dimensions of the post, such as the width or diameter of the post.

Forms of the bracket have a first part in the form of a first end, typically the first end is a loop arrangement defining an internal void, gap, space or the like formed by walls or wall sections of the bracket. Forms of the bracket have one or more outwardly extending extensions. Typically, the extensions form a loop, such as the loop for engaging the building component. More typically, the shape of the loop corresponds to the shape of the post, more typically the size of the loop matches the size of the post so that the post is received within the loop to locate or position the bracket along the length of the post at the desired or at a convenient location where the bracket can be secured to the post. Even more typically, the profile of the post and of the loop are matched together, typically, the post and loop are close fitting with each other.

Forms of the bracket have a loop which is of a size corresponding to the dimensions of the post, typically allowing the loop of the bracket to be close fitting with the sides or walls of the post. In one form the shape of the loop is generally rectilinear, being square or rectangular, or is round, such as by being circular.

Typically, the loop, preferably formed by a pair of outwardly extending extensions, typically in the form of arms or similar, arranged to be at least partially in end-to-end relationship, is of a square section. In one form, the loop is formed from one or more elongate members or elements in the form of arms. More preferably, the two arms are preferably bent, inclined or folded towards each other to form a void. In one form, the loop is a substantially continuous loop. However, in some forms, the loop is provided with a discontinuity, typically in the form of a gap, space, slot, slit, or similar formed at the ends of the arms.

More typically, the discontinuity is formed at the ends of the two arms by the two ends of the arms being in opposed end-to-end spaced apart relationship to each other, preferably slightly spaced apart. In forms of the bracket, the two arms can be in touching relationship with each other. Forms of the bracket allow the loop or void to be expanded, such as by temporarily slightly separating the ends of the arms from each other to facilitate receiving the post in the loop or void. Typically, the loop resumes its original shape or size around the post. In one form the arms of the loop are resiliently deformable or deflectable.

In one form, the brackets are provided with holders or receiving portions for receiving the edges or sides of the AAC panels, typically holding or receiving the corner edges or sides of the panels, more typically receiving the corner edges located at one end of the panels.

In one form, the receiving portions are holders for the panels, typically in the form of trays for supporting the panels. In one form, the tray includes a base. Typically, the base of the tray is in the form of a plate, typically a cleat plate, cover plate, base plate or the like. Preferably, in one form of the bracket the plate forms the base or floor of the tray for locating and/or supporting the edge or corner of the panel thereon, preferably from underneath the panel, when the end of the panel is received in the tray and is near to the post, such as by being fully received or fully home within the tray. Typically, the holder tray or similar has side walls, more typically, side walls are in parallel spaced apart relationship on opposite sides of the plate. In one form, the walls extend in one direction and are closed by the base plate, whereas in another form the walls are in the form of wings which extend in a second direction and are open at their distal ends. Typically, the first and second directions are opposite directions.

In use, the two different versions of the bracket can be oriented so that the tray can face upwardly or the tray can face downwardly depending upon the required orientation of the bracket. When the tray faces upwards, the tray of the bracket supports the panel from underneath the panel, such as at the base or lower edge of the panel, and when the tray faces downwards, the bracket retains the panel in place from the top of the edge of the panel by engaging the upper edge of the panel to either temporarily or permanently retain the panel from lateral movement, either alone or in combination with other brackets or other fittings or posts of the fence.

It is to be noted that the orientation of the arms of the bracket can change in accordance with the change in orientation of the tray part of the bracket. In the stepped form of the bracket, the extension can be regarded as being in a lower arm orientation. In the aligned form of the bracket, the extension arm can be regarded as being in the upper arm orientation.

In one form of the bracket, the extensions are in the form of arms, typically sideways extending arms. In one form of the bracket, the arms are in one orientation, which is that the arms are in stepped relationship with the base plate, whereas in other forms of the bracket, the outwardly extending arms are in a different orientation in which the arms are in substantial alignment with the base plate.

Forms of the brackets are provided with apertures, typically fastening apertures for receiving therethrough suitable fasteners to attach the brackets to the upright posts and/or AAC panels. The fasteners may be any suitable or convenient fasteners. The brackets can have any number of apertures, which can be for different purposes. Forms of the bracket have apertures arranged singly, in pairs, in groups of 3 or more, in spaced apart locations. Forms of the brackets have apertures, typically, multiple apertures in any suitable or convenient part or portion including in the arms, in the trays, in the loops, in the ends or the like.

Forms of the brackets are provided with surface irregularities and/or discontinuities. Typically, forms of the irregularities/discontinuities are projections or depressions which extend outwardly or inwardly from the surfaces of the brackets. In one form, the projections are bumps, ridges, ribs, bosses, dimples or similar. The bumps may be arranged singly, in pairs, or in spaced apart groups of three or more separate projections.

Forms of the brackets are provided with depressions including cavities, dimples, hollows, grooves, rebates, or the like.

Forms of the brackets have projections or depressions aligned with the location of the heads of suitable fasteners to receive the heads of the fasteners in the depressions formed on one side of the bracket at the same location as the projection which is formed on the other side of the brackets so that the brackets provide a substantially flat surface to contact the AAC panels or fibre cement sheets forming part of the fence structure but have a clearance gap or space coincident with the fastener so as to receive the head of the fastener therein. It is to be noted that the various parts of the brackets having the projections/depressions bear against the corresponding surfaces of the AAC panels, FC sheets, or other components of the fence having flat surfaces.

Forms of the brackets retain the AAC panels in place by restraining the AAC panels from lateral movement. However, other forms of the bracket do not retain the AAC panels in place by not restraining movement of the panels laterally but supporting the AAC panels only.

In forms of the fence, other components retain the AAC panels in place by restraining lateral movement of the panels. Examples of other components include covers, capping, covering, facades, and the like. Examples of the covering include strips, panels, sheets, or the like. The covering may be made from any suitable material. However, fibre cement (FC) is a preferred material from which the covering is made. In one form, the covering covers the post. However, the covering can cover any part of the fence including one or more posts, one or more panels, one or more brackets, combinations of posts and panels, and optionally combinations of brackets and panels including joins between posts and panels and between panels and panels.

Forms of the fence made using forms of the brackets and panels can have any number of panels stacked in abutting relationship one above the other. In one form, the fence is three panels high, such as for example, about 1.8 m high. However, other forms of the fence can have any number of panels from one panel to about five or six panels, depending upon circumstances and requirements with the proviso that the height and structure of the fence is fully compliant with all relevant building and council regulations and be assembled in accordance with all relevant instructions and specifications, including any special conditions imposed by any relevant authority, such as for example, local council or a local building inspector so as to be safe to use.

### BRIEF DESCRIPTION OF THE DRAWINGS

Embodiments of the brackets and of how the brackets are used to form structures such as fences, will now be described by way of example to illustrate forms of protection with reference to the accompanying drawings in which:

FIG. 1 is a perspective view of one form of a bracket having a stepped configuration shown in isolation.

FIG. 2 is a perspective view of one form of a bracket having an aligned configuration shown in isolation.

FIG. 3A is a perspective view of three spaced apart posts having one or other form of the bracket of FIG. 1 or 2 attached thereto about which a corner section of one form of a fence is to be constructed.

FIG. 3B is an enlarged view of circle A of FIG. 3A.

FIG. 3C is an enlarged view of circle B of FIG. 3A.

FIG. 4 is a perspective view of the corner section of one form of a fence showing the lowermost row of panels being supported in position by a first row of one or other of the forms of the bracket of FIG. 1 or 2 located at the lower edge of the panel and a second row of brackets located at the upper edge of the first row of panels.

FIG. 5A is an enlarged view of circle C of FIG. 4.

FIG. 5B is an enlarged view of circle D of FIG. 4.

FIG. 5C is an enlarged view of circle E of FIG. 4.

FIG. 6 is a view similar to FIG. 3 but showing three rows of panels located in edge to edge abutting relationship one above the other to form the full height of this form of the fence.

FIG. 7 is an enlarged view of circle F of FIG. 6 showing the detail at the top of the corner post.

FIG. 8 is an enlarged view similar to FIG. 7 showing one form of optional capping located at the top of the corner post for finishing the fence.

FIG. 9 is a perspective view of another form of a bracket having a stepped relationship shown in isolation.

FIG. 10 is a perspective view of another form of a bracket having an aligned relationship shown in isolation.

### DETAILED DESCRIPTION

One form of a bracket suitable for use in making a fence will now be described with reference to FIG. 1.

This form of the bracket, generally denoted as 10, is referred to as being in the stepped configuration because the loop or void of the bracket is not in alignment with the plane of the base of the tray portion but rather than base of the tray and the loop are in a shaped relationship to each other. Bracket 10 has generally two parts in which the first part is a loop or void portion in the form of a loop 12 for attaching bracket 10 to an upright support member of a fence, such as for example, a vertical post, and the second part which is a receiver in the form of a tray portion 14, for use in receiving an edge of a panel for supporting or holding the panel which is an infill panel of the fence, typically an AAC panel, block or slab, such as a Hebel® panel. Loop 12 is located at or towards one end of bracket 10 and forms an extension of the bracket which extends in a first direction of bracket 10, whereas tray portion 14 is located at or towards the other end of bracket 10 and is arranged to extend in the opposite direction to the direction of extension of loop 12.

Loop 12 is formed by two outwardly extending extensions in the form of side arms extending from bracket 10 which are first side arm 16 located along one transverse side of bracket 10 and second side arm 18 located along the opposite transverse side of bracket 10. Both side arms 16,18 extend in the same direction on opposite sides of bracket 10. First side arm 16 has two sections being a proximal section 20 located more inboard of arm 16, towards tray portion 14, and a distal section 22 being located along the first end of bracket 10 at the outboard end of loop 12. Distal section 22 is arranged to extend substantially at right angles from proximal section 20 by being bent, folded, inclined, twisted or the like thereto.

Second side arm 18 also has two sections, being proximal section 24 extending transversely from a more inboard position of bracket 10 near to tray portion 14, along the opposite transverse side of bracket 10 in a direction towards the first end of bracket 10 being the loop portion 12 and a distal section 26 located at the first outboard end of bracket 10. Distal section 26 is arranged to extend substantially perpendicularly from the end of proximal section 24 by distal section 26 being bent, folded, inclined, twisted or similar with respect to proximal section 24. Proximal sections 20, 24 are arranged to extend collinearly in opposite directions along the outer or loop end of the bracket 10 from their respective proximal sections, 20,24 at either side of bracket 10.

It is to be noted that the direction of extension of distal sections 22, 26 are in opposite directions to one another so that the respective ends of the distal sections 22, 26 of arms 16, 18 are in end to end facing relationship with each other, preferably in end to end touching relationship to each other with a line of contact there between. Thus, loop 12 is formed into a substantially square shape by having four sides, namely proximal section 20 forming one transverse side, distal section 22 and distal section 26 forming one side at the first end, proximal section 24 forming the other transverse side, and part of tray 14 (being middle plate 48 extending from edge 46 as will be described in more detail later) forming the fourth side.

Distal section 22 of arm 16 is provided with a single aperture 28 whereas proximal section 20 of arm 16 is provided with a pair of spaced apart apertures 30a, 30b.

Distal section 26 of arm 18 is provided with a single aperture 32, whereas proximal section 24 of arm 18 is provided with a pair of apertures, generally denoted as 34 in spaced apart relationship to each other. It is to be noted that only one aperture 34 is shown in FIG. 1, the other aperture being obscured by tray 14 of the bracket. Apertures 28, 30, 32, 34 are for use in attaching or mounting bracket 10 to the upright support member of the fence by receiving suitable fasteners therethrough to secure bracket 10 in place on the support as will be described in more detail later.

Further, it is to be noted that the apertures can have any type, shape, size or profile, be of any suitable size and/or be located at any convenient location, including being single apertures, pairs of apertures, or groups of three or more apertures in spaced apart relationship.

A discontinuity in the form of a gap or space, such as a slot 36, is located intermediate the ends of distal section 20, 24 of arms 16, 18 as a line of contact of the ends of the arms to allow bracket 10 to flex or expand when being fitted to the upright to facilitate bracket 10 being received over the upper end in use of the upright support or post. Although one form of discontinuity in the form of slot 36 is described and illustrated, the first end side of loop 12 can have other forms, such as for example being continuous in some forms of bracket 10, depending upon the method of manufacture of bracket 10. In one form, the ends of the respective distal sections 20, 24 are in face-to-face opposed spaced apart relationship to each other.

The tray portion 14 of bracket 10 of FIG. 1 will now be described in detail.

First side arm 16 extends along the first transverse side from tray portion 14. The first transverse side of tray 14 is first side wall 38 located at the first transverse side of bracket 10. Side wall 38 is of a generally polygonal shape having two opposite parallel edges extending perpendicularly to the transverse direction of first arm 16, an outer edge extending substantially parallel to the lengthwise extending direction of first arm 16 and an inclined edge extending between outer edge and the parallel edge along the second end of bracket 10. It is to be noted that the proximal section 20 of arm 16 and wall 38 are coplanar forming the first transverse side of bracket 10 as shown in FIG. 1.

A similar wall arrangement is provided on the second transverse side of bracket 10 on the opposite side of bracket 10 so that second wall 40 on the second transverse side of bracket 10 is similar in shape to first wall 38 and walls 38, 40 are mirror images of each other and are in spaced apart relationship to each other. Also, second wall 40 is coplanar with proximal section of second arm 18 to form the second transverse side of bracket 10.

Tray portion 14 includes a base portion in the form of a base plate 42 which extends between the upper edges of wall 38 and wall 40 and is in stepped relationship with the edges of first arm 16 and second arm 18 by extending outwardly from the edges of arms 16, 18 as shown in FIG. 1. A partition in the form of a solid middle plate 46 extends internally into bracket 10 from the inboard edge 48 of base plate 42 in the direction towards arms 16,18. Middle plate 46 divides bracket 10 into loop portion 12 and tray portion 14. In use when a panel is received in tray 14 the edge or end of the panel abuts against middle plate 46. Thus, tray portion 14 comprises first wall 38, second wall 40, base plate 42 and middle plate 46.

Tray portion 14 forms a holder, retainer or receiver for supporting and/or locating one or more edges, typically a corner edge having two sides, of an AAC building panel of the fence.

Base plate 42 is provided with central aperture 44. In use, base plate 42 forms the floor or base of tray portion 14 which is one form of the receiver or holder of the connector.

The form of the bracket shown in FIG. 1 is in the stepped configuration in which base plate 42 is spaced apart from arms 16, 18 since the plane containing base plate 42 is spaced apart from the plane containing the edges of the first and second arms 16, 18. In the stepped configuration the arms 16,18 are referred to as being the lower arms because in one orientation of bracket 10 the arms 16,18 are located at a level lower than the level of base plate 42.

Further, it is to be noted that bracket 10 can be used in two different orientations in use. In one orientation, tray portion 14 faces downwards as shown in FIG. 1. The other orientation is when tray 12 faces upwardly in which base plate 42 is the base of the tray and walls 38,40 extend upwardly. Thus, in one orientation bracket 10 with tray portion 14 facing upwards can be used for supporting the AAC panel from below by being located underneath the lower edge of the AAC panel.

In the other orientation in which tray portion faces downwards, bracket 10 retains the AAC panel in place by the tray portion being received over the upper edge of the panel to prevent lateral displacement of the panel.

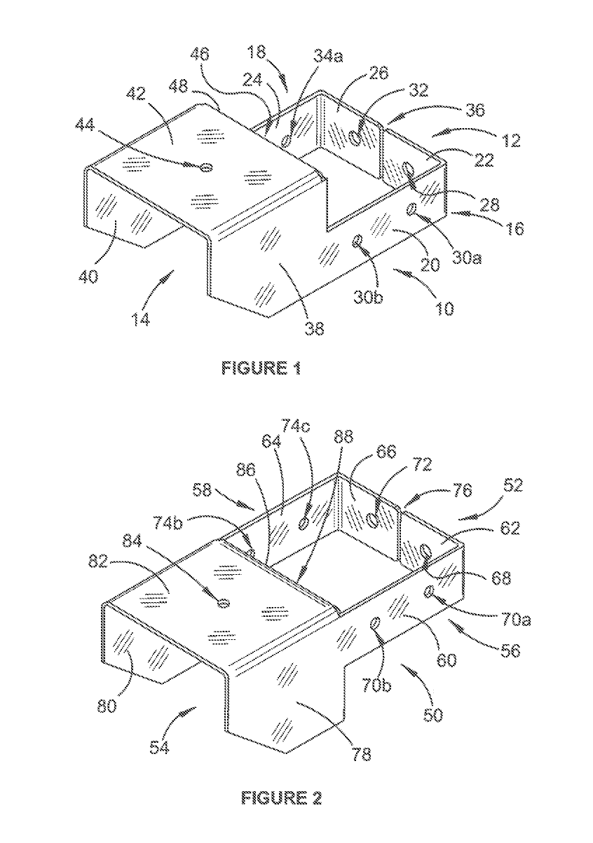

Another form of the bracket, also suitable for use in assembling a fence, is illustrated in FIG. 2 and will now be described in detail. This form of the bracket, generally denoted as 50, is referred to as an aligned form or configuration of the bracket because the arms of the bracket are in the aligned relationship with the base of the tray part of the bracket. In this form of the bracket the plane of the base of the tray is substantially in the same plane as the upper edges of the arms in the orientation of the bracket as shown in FIG. 2.

Bracket 50, also has two parts, being a loop portion 52 and a tray portion 54, which are arranged to extend generally in alignment with each other but in opposite directions at different ends of bracket 50. This form of the bracket is also referred to the upper arm form or the alignment form of the bracket because arms 56,58 forming the loop portion 52 are in substantially in alignment with tray portion 54, or more particularly the base plate of the tray portion 54 as shown in FIG. 2 as will be described in more detail below.

Loop portion 52 is similar to loop portion 12 of bracket 10 of FIG. 1 and comprises first side arm 56 and second side arm 58 extending generally transversely at either transverse side of bracket 50. Bracket 50 is similar to bracket 10 and has the following parts.

Loop part 52, tray portion 54, first side transverse arm 56, second side transverse arm 58, first side proximal section 60, first side distal section 62, second side proximal section 64, second side distal section 66, first side distal section aperture 68, first side proximal section pair of apertures 70a, 70b, second side distal section single aperture 72, second side proximal section pair of apertures 74a, 74b, slot 76 located between the distal ends of the pair of distal sections 62,66 in end-to-end relationship, first side wing 78, second side wing 80, base plate 82, middle plate 86, inboard edge 88 of base plate 82 and base plate aperture 84. The shapes of the individual parts of bracket 50 are the same as the shapes of the corresponding parts of bracket 10.

In this form of bracket 50, tray portion 54 is formed from wing 78, wing 80, base plate 82, and middle plate 86 with the base or floor of tray 54 being base plate 82 having aperture 84. Middle plate 86 extends internally into bracket 50 from inboard edge 88 of base plate 82 for dividing bracket 50 into loop partition 52 and tray portion 54.

It is to be noted that bracket 50 can be used in two different orientations. One such orientation is where tray 52 is facing upwardly in which base plate 82 is the floor of the tray, whereas the other orientation is where tray 54 is facing downwardly as shown in FIG. 2, in which base plate 82 forms, in effect, the lid, top or roof of the tray. In the orientation of bracket 50 as shown in FIG. 2, the arms are referred to as being in the upper configuration or as being the upper arms since the arms are locate at the upper part of the bracket substantially in alignment with base plate 82.

Bracket 50 is similar to bracket 10 except that
(i) the location of first arm 56 and second arm 58 of bracket 50 is different to the location of first arm 16 and second arm 18 of bracket 10 with respect to the respective loop portions of the different brackets,
(ii) the first and second wall sections of bracket 50 are in the form of wings 78, 80, the upper portions of which extend in the plane of the first and second transverse sides of bracket 50 to form the aligned form of the bracket, and
(iii) base plate 82 having aperture 84 is located at about the same level as the edges of first and second arms 56, 58 so that base plate 82 is in substantial alignment with the edges of first arm 66 and second arm 68, i.e. is in the aligned form of the bracket.

Thus, bracket 50 of FIG. 2 is the upper arm form of the bracket in which the arms 56, 58 are more or less an extension of the proximal part of wings 78, 80 so that base plate 82 is more or less in alignment with edges of arms 56, 58.

Bracket 50 can be used in two different orientations, being the orientation for supporting an AAC panel from above as shown in FIG. 2, in which the upper edge of the panel is received in tray portion 54 for being supported from above against lateral displacement and the opposite orientation in which bracket 50 is located underneath the AAC panel in which the lower edge of the panel is received in tray portion 54 for supporting the panel since wings 78,80 extend upwardly on either side of the panel received in tray 54.

It is to be noted that bracket 10 and bracket 50 are complementary to each other in shape so that the respective loop portions 12, 52 of both brackets 10, 50 respectively, can be located in abutting side-by-side relationship one on top of the other at or towards one end of the bracket so that the respective ends overlap each other, particularly the two sets of arms 16, 18 and 56, 58 in abutting relationship one above the other when the brackets are located on the same upright support or post. In this regard, it is to be noted that the widths of the arms of the brackets is about half the length of the walls or wings of the bracket so that the arms of the respective brackets extend about the same height in opposite directions and the width of the cooperating brackets is constant over the length of the brackets. As the widths of the respective one ends of the brackets are about half the widths of the other respective ends of the brackets when the brackets are in reverse oriented overlapping relationship, the width of the combined bracket is more or less constant over the length of the brackets, being about the same as the widths of the second ends of the brackets.

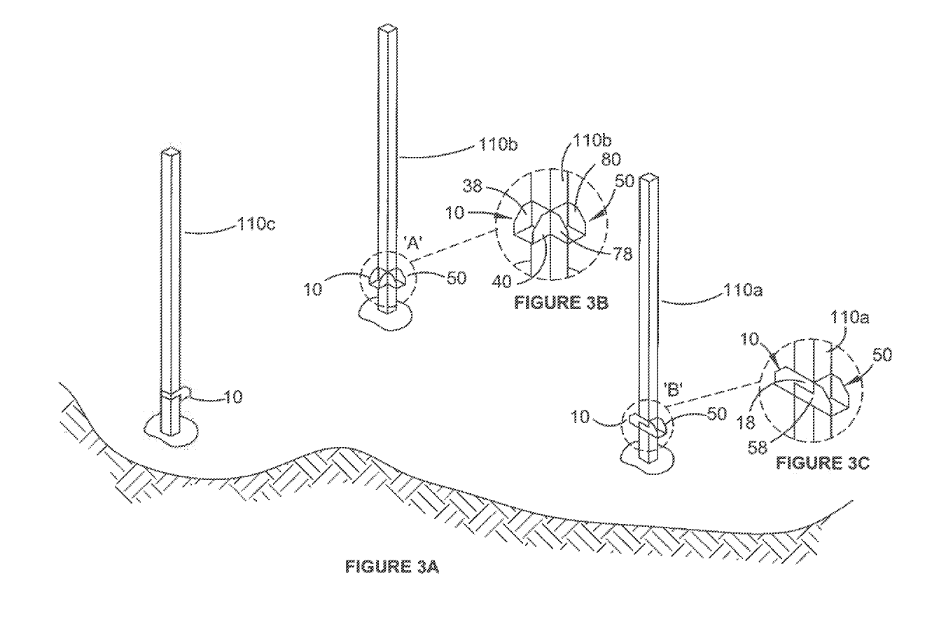

Use of brackets 10, 50 in different combinations and indifferent orientations to build one form of a fence will now be described with reference to the drawings, particularly FIGS. 3 to 8.

In one form of the fence, three individual upright support members, typically in the form of posts 110a, 110b, 110c, and more typically having the form of square section hollow tubing, particularly in the form of box tubes, are located in the ground at spaced apart locations to form the line of the fence, such as for example, to form a corner section of the fence, as shown more particularly in FIGS. 3 to 7. The spacing apart of posts 110 corresponds to the length of the AAC panels from which the fence is to be constructed.

Typically for each post, a hole is formed in the ground, such as by excavating soil from the ground at the desired location to form the hole. Post 110a, is placed in the hole, and positioned to be level so as to extend vertically upright with the aid of spirit levels. The hole is then filled with a suitable filler and/or packing material, such as cement or other cementitious material, preferably a quick drying cement or concrete, or other material which cures quickly to secure post 110a in position so as to extend vertically.

A second and a third hole are formed in the ground in spaced apart relationship to each other at the desired locations for receiving posts 110b, 110c and the procedure described above repeated to secure vertical posts 110b, 110c securely in position at the selected spaced apart locations corresponding generally to the length of the AAC panels.

Referring to first post 110a, a first bracket 50 being of an aligned form or configuration having an upper arm form, is located over the upper end or top of post 110a, in an orientation for supporting the panel from underneath. Post 110a is received through the square opening formed in loop 52 of bracket 50 to locate bracket 50 on post 110a. It is to be noted that first bracket 50 is in an orientation so that the tray 14 of bracket 50 is oriented in the upwardly facing orientation in which base plate 82 forms the floor of the tray in preparation for receiving a panel therein to support the panel from underneath the panel. A second bracket 10 of a stepped configuration having the lower arm configuration, is also located over post 110a in an orientation for supporting the corresponding panel from underneath.

Post 110a is received through loop 12 of bracket 10. It is to be noted that the arms 16,18 of bracket 10 are located in register with and above arms 56,58 of bracket 50 on post 110a of FIG. 3.

Second bracket 10, also oriented with tray 14 facing upwardly with base plate 42 forming the floor of the tray, supports the panel located therein from underneath. It is to be noted that first bracket 50 and second bracket 10 are oriented so as to extend collinearly on either side of post 110a but in opposite directions as shown in FIG. 3 with the respective arms 16,18 of bracket 10 in register with and in abutting relationship with arms 56,58 of bracket 50 so that arms 16,18 are located above arms 56,58. In this position, the arms of the second bracket 10 overlie and are in edge-to-edge abutting relationship with the arms of first bracket 50. Brackets 10, 50 are secured in place by suitable fasteners such as screws, preferably Tek screws or bugle headed screws, being received through the respective apertures of the loop of each bracket such as apertures 70,74 of bracket 50 and apertures 30,34 of bracket 10 to secure the bracket to the post. Both brackets with the respective trays facing upwards are ready to support the AAC infill panels.

Referring now to second upright post 110b of FIG. 3, this post forms a corner post for the section of the fence illustrated in the drawings. A first bracket 50 in an orientation in which tray portion 54 faces upwardly is located over the top of post 110b and allowed to slidingly move down post 110b to adopt a position close to ground level corresponding to the level of the first row of panels of the fence. It is to be noted that first bracket 50 is an upper arm form or aligned configuration of the bracket. First bracket 50 on post 110b is located in an orientation in which tray 54 faces upwardly for receiving a lower corner edge of a panel.

A second bracket, being in the form of bracket 10, in an orientation in which tray 14 faces upwardly, is then placed over the top of post 110b to slide lengthwise along the length of the post to rest against first bracket 50 with loop 12 of bracket 10 resting upon loop 54 of bracket 50 so that the two brackets are in abutting overlapping relationship with each other at the same level so that respective trays 14, 54 are in the same upwardly facing orientation for supporting the respective panels on either side of post 110b from underneath the respective lower edges of the panels and both extend perpendicularly to one another in different directions for receiving the respective lower corners of the lower level of panels forming part of two sides of the fence at right angles to each other. In this configuration of brackets, arms 56,58 of bracket 50 are at the bottom of the two brackets, and arms 16,18 of bracket 10 are at the top of the combination as shown more particularly in FIG. 3B.

Referring now to the third upright post of FIG. 3 being post 110c, third upright post 110c is located and fixed in place to extend vertically at a spaced distance from second post 110b. The distance apart of post 110c from 110b corresponds to the length of the panel that is to extend therebetween. A first bracket 10 of a stepped configuration, and in an orientation in which tray 14 faces upwardly for supporting the panel from underneath is located over the top of post 110c so that the post is received within loop 12 of bracket 10. Bracket 10 is allowed to slide lengthwise along the length of post 110c to adopt a position near to the base of post 110c. Bracket 10 is in a configuration with tray 14 facing upwards to receive the lower edge or corner of a panel for supporting the panel from underneath. In this form, a single bracket 10 only is required on post 110c since post 110c forms the end of the fence.

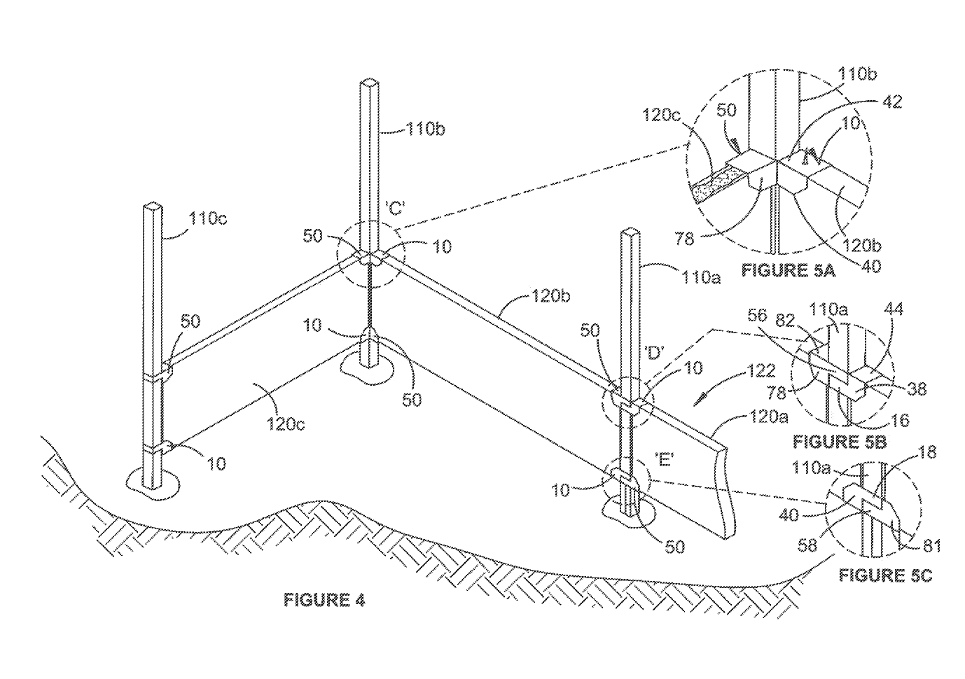

When all of the brackets 10, 50 forming the lowermost or first level of brackets are secured in place at the selected positions on the respective posts 110, in the respective correct orientations, in this case all having the respective trays facing upwardly, the first row or lower level of panels 120a, 120b, 120c, as shown more particularly in FIG. 4 are located in the upwardly facing trays 14, 54 of the respective brackets 10, 50 as shown more particularly in FIG. 4 to form the lower row 122 of panels 120a,120b,120c of the fence.

The required number of brackets to form the next row or second lowest row of brackets being a combination of brackets 10 and brackets 50, are then placed over the upper end or top of each post 110 as required. The next level of brackets is placed over the top of the posts win an orientation in which trays 14, 54 of brackets 10, 50 are facing downwards so that the upper edge or upper corners of each of panels 120a,120b,120c are located within the respective downwardly facing trays to further secure panels 120 in place by maintaining the panels in alignment with the fence line by preventing sideways or lateral displacement of the panels. It is to be noted that the first bracket of the second row of brackets on post 110a is the stepped configuration of the brackets, being bracket 10, whereas the second bracket is bracket 50 of an aligned configuration so that the respective arms of brackets 10,50 overlap each other with arms 56,58 of bracket 50 overlying arms 16,18 of bracket 10.

The first bracket of the second level of brackets on post 110b is bracket 10 in an orientation in which tray 14 faces downwardly whereas the next bracket of the second level of brackets on post 110b is bracket 50 also in an orientation with tray 54 facing downwardly so that the respective arms are in abutting edge-to-edge relationship one above the other bas shown in FIG. 5A.

Turning now to post 110c, the form of the bracket forming the second level of brackets is bracket 50 in an orientation in which tray 54 faces downwards. Thus, in this embodiment as described and illustrated, all of brackets 10,50 of the second level of brackets are oriented with the respective tray portions facing downwards, so as to support the respective panels from above.

Each bracket 10, 50 of the second level of brackets is secured to the first row of panels by a suitable fastener, such as for example, a Tek screw or bugle headed screw or similar being received through central aperture 44, 84 of base plate 42, 82 of tray 14, 54 respectively of each bracket 10, 50 as shown more particularly in FIG. 5.

When all of the rows of panels and all of the sets or levels of brackets are secured in place, the fence can be completed to provide protection for the fence and to improve the appearance of the fence.

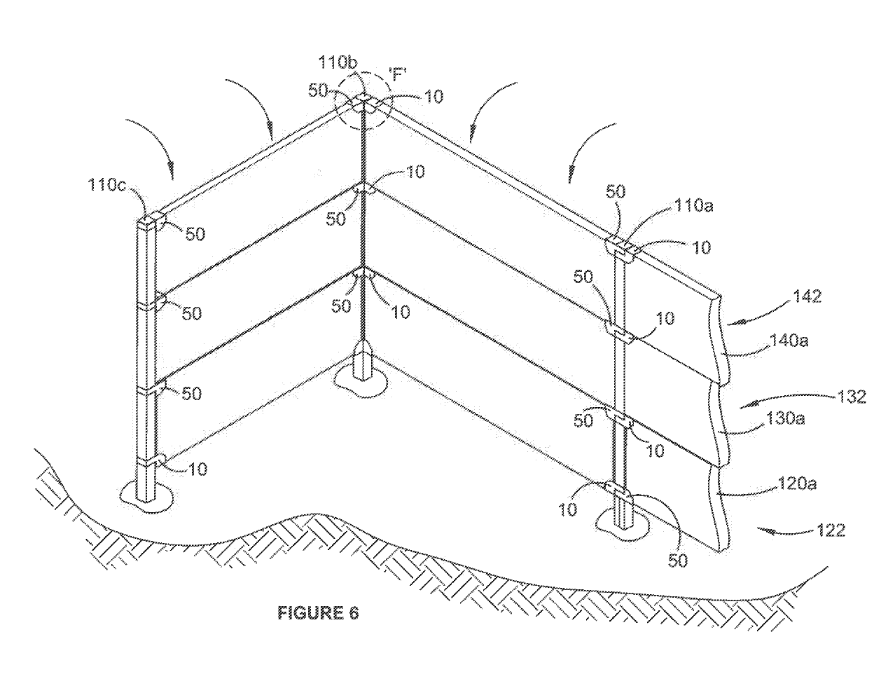

With particular reference to FIG. 6, each post 110 is provided with successive alternating rows of brackets and panels 132, 142 which are assembled together around and between posts 110 to form the fence. In one form of the fence there are four rows of brackets and three rows of panels being rows 122, 132 and 142. Each row of panels has three panels in the form of the fence shown in FIGS. 6 and 7. Row 120 has panels 120a,120b,120c; row 130 has panels 130a,130b,130c; and row 140 has panels 140a,140b, 140c. However, it is to be noted that the brackets of the uppermost row of brackets above row 140 always have trays 14, 54 facing downwards to hold all of the panels in place and to provide a level top or upper surface for the fence. Thus, in effect the panels are clamped between the lower level or row of brackets all facing upwards and the top level or row of brackets all facing downwards. Additionally the second and third level or row of brackets prevents sideways movement of the panels.

One form of completing the fence includes providing covering and/or capping. When all of the three rows of panels are secured to the respective brackets and posts, lengths or strips of covering are located at the posts to extend over the edge of the panels to further restrain the panels with respect to the posts to prevent lateral movement of the panels even though some of the edges of the panels are not located in the trays of the various brackets.

In forms of the fence, the joins between adjacent panels, such as at the posts to which the adjacent panels are attached, are covered by a suitable covering. The covering can be of any suitable form, type or material. A preferred form of the material is fibre cement (FC), including fibre reinforced cement or similar. One form of the covering is strips of FC, whereas other forms include squares, rectangles, panels, sheets or other essentially planar members of any suitable shape or size.

In FIG. 7, which is an enlarged fragmentary view of one corner of the fence of circle F of FIG. 6, the covering is in the form of FC strips extending substantially vertically in alignment with the corner post of which post 110b is an example. Post 110b is located at the junction of two panels 140b, 140c which are retained in place by brackets 10, 50 oriented so that the respective trays face downwardly to engage the sides of the upper edge of the panels. Suitable fasteners are received through the apertures in the side arms of the brackets. One form of the covering includes a first cover strip and a second cover strip for the inner corner. A first inner FC strip 160, is located along the inner side of panel 140b adjacent post 110 to retain panel 140b against post 110. A second inner FC strip 162, is located along the inner side of panel 140c adjacent post 110 and the inner edge of cover strip 160 to retain panel 140c in place against post 110. Thus, cover strips 160,162 protect the inner corner of the fence.

Covering is also provided on the external corner of the fence. The external covering includes a first outer FC cover strip 164 which is located on the outer side of the fence to cover post 110, and the join between post 110 and panel 140b to retain panel 140b in place. A second outer FC cover strip 166 is located on the other outer side of the corner of the fence to cover post 110, the join between panel 140c and post 110 and panel 140c to retain panel 140c in place against post 110. Thus, cover strips 164,166 provides protection for and enhance the appearance of the outer corner of the fence.

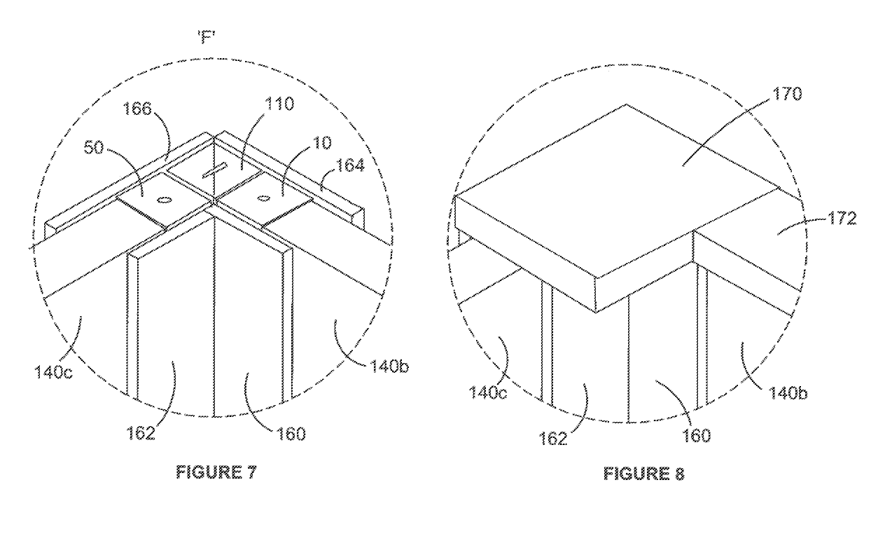

An optional construction of a corner of fence 122 is illustrated in FIG. 8 which is a similar view to FIG. 7 but with a cap on the top of the post. FIG. 8 shows capping applied to the upper edges of the fence, more particularly the upper edges of panels 140b, 140c and post 110.

In this embodiment, capping in the form of a corner cap 170, typically made from any suitable material, including AAC, FC, or compressed FC or similar is of a generally square or rectangular shape and is placed at the top of the corner of fence 122 to cover the top of post 110 and upper edges of panels 140b, 140c. Cap 170 can be secured to post 110 and panels 140 in any suitable manner, such as by the use of a suitable fastener, bonding agent or the like.

The capping also includes a first cap strip 172 extending from corner cap 170 along the upper edge of panel 140b. In one form, strip 172 is wider than the thickness of panel 140b so that there is an overhang on both sides of fence 122 to provide protection and enhance the appearance.

A second strip (not shown) similar to the first strip 172 is provided along the upper edge of panel 140c to complete the appearance of fence 122 and provide protection for the fence.

The covering in the form of individual covers can be any suitable type and made from any suitable material.

In some embodiments (not shown), the second row of brackets 10, 50 are arranged with one or more tray 14, 54 facing upwards with the back of base plates 42, 82 resting upon the upper edge of panels 120. Suitable fasteners are received through central apertures 44, 84 to fasten panels 120 to bracket 10, 50 to secure the panel in place. In other embodiments, it is to be noted that all of the brackets in each row of brackets of the fence have their respective trays facing upwards except for the top row of brackets along the upper edges of the top row of panels forming the fence which brackets are oriented with the tray facing downwards so as to support the panels from above.

In some embodiments, the one row of brackets about the same post can include a pair of brackets one on top of the other in abutting relationship with the lower of the pair of brackets having a downwardly facing tray and the upper of the pair of brackets having an upwardly facing tray with the base plates of the two brackets in contact with each other in back-to-back abutting relationship one above the other with the perspective trays facing in opposite directions.

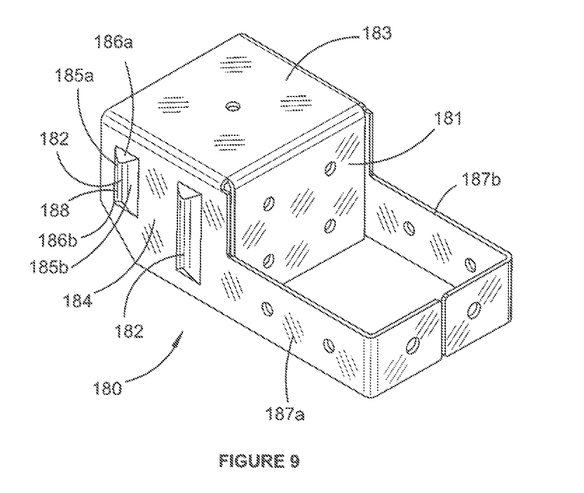

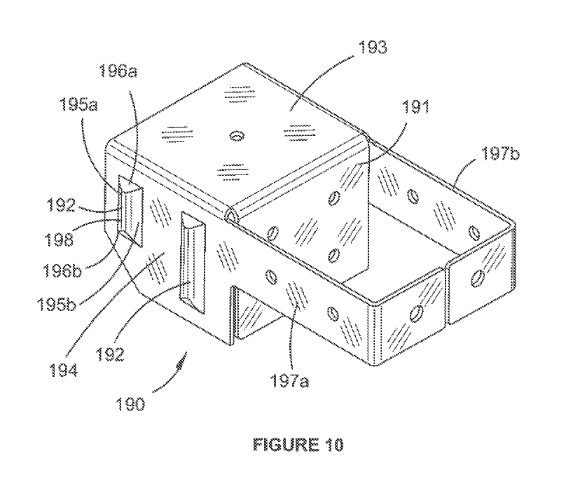

Another form of both types of brackets will now be described with reference to FIGS. 9 and 10.

The form of the brackets shown in FIGS. 9 and 10, being brackets 180 and 190 respectively, are similar to brackets 10, 50 respectively and have the same configuration and parts and structure with the addition of projections in the walls or wings of the bracket. One form of the projections is ridges 182,192 formed in the side walls 184 or wings 194 of brackets 180, 190 respectively as shown in FIGS. 9 and 10. Ridges 182, 192 can have any suitable or convenient form. One form of ridges 182, 192 comprise tapering side walls and tapering ends. The position of individual ridges of brackets 182, 192 correspond to where the heads of screws or other fasteners, such as Tek screws or bugle head screws are located for providing a substantially flat surface to bear against the panels and/or the fibre cement sheets or strips or similar. The remaining parts, shape, configuration and style of brackets 180, 190 is the same as brackets 10, 50 respectively.

One form of bracket 180 will now be described in detail. Bracket 180 is provided with a ridge 182 located on wall 184. One form of ridge 182 has a pair of generally tapered or inclined sides 185a,185b and a pair of tapered or inclined ends 186a,186b. One tapered side wall 185a is located so as to face the open end of the tray portion of this form of the bracket whereas the other tapered wall 185b is located so as to face in the direction towards side arms 187a, 187b of bracket 180.

Tapered end wall 186a extends between tapered side wall 185a, 185b at one end of ridge 182 whereas tapered end wall 186b extends between tapered side walls 185a, 185b at the other end of ridge 182. The tapered walls, including both side 185a,185b and end walls 186a,186b are generally curved or non-rectalinear.

Projections 182 can have any suitable shape or form. Forms of projection 182 include the forms of an elongated dome, hump, convexity, bulge, nodule, bump or the like. A rib 188 or other line or region extends from one end 186a to other end 186b along the join or junction of oppositely inclined tapered walls 185a,185b. In one form the shape of ridge 182 is generally elongate having a central lengthwise extending axis along the plane that includes rib 188.

Forms of bracket 180 can have any suitable or convenient number of ridges 182. Although two ridges 182 in side by side relationship in wall 184 are illustrated, there can be any number of ridges, such as for example, two spaced apart ridges in wall 184 as illustrated in FIG. 9, or in other locations.

Ridges can be provided in any side or part of bracket 180, including in both side walls, in middle plate, in the side arms, or in base plate as required.

Ridges 182 can be of any suitable type, shape, size, profile or style. Two differently sized ridges in spaced apart relationship are shown in FIG. 9.

It is to be noted that bracket 180 as illustrated in FIG. 9 shows middle plate 181 extending from the inboard edge of base plate 183. Middle plate 181 is the same as middle plate 46 of bracket 10.

One form of bracket 190 will now be described in detail.

Bracket 190 is provided with a ridge 192 located on wall 194. One form of ridge 192 has a pair of generally tapered or inclined sides 195a,195b and a pair of tapered or inclined ends 196a,196b. One tapered side wall 195a is located so as to face the open end of the tray portion of this form of the bracket whereas the other tapered wall 195b is located so as to face in the direction towards side arms 197a, 197b of bracket 190.

Tapered end wall 196a extends between tapered side wall 195a, 195b at one end of ridge 192 whereas tapered end wall 196b extends between tapered side walls 195a, 195b at the other end of ridge 192. The tapered walls, including both side 195a,195b and end walls 196a,196b are generally curved or non-rectalinear.

Projections 192 can have any suitable shape or form. Forms of projection 192 include the forms of an elongated dome, hump, convexity, bulge, nodule, bump or the like. A rib 198 or other line or region extends from one end 196a to other end 196b along the join or junction of oppositely inclined tapered walls 195a,195b. In one form the shape of ridge 192 is generally elongate having a central lengthwise extending axis along the plane that includes rib 198.

Forms of bracket 190 can have any suitable or convenient number of ridges 192. Although two ridges 192 in side by side relationship in wall 194 are illustrated, there can be any number of ridges, such as for example, two spaced apart ridges in wall 194 as illustrated in FIG. 9, or in other locations.

Ridges can be provided in any side or part of bracket 190, including in both side walls, in middle plate, in the side arms, or in base plate as required.

Ridges 192 can be of any suitable type, shape, size, profile or style. Two differently sized ridges in spaced apart relationship are shown in FIG. 10.

It is to be noted that bracket 190 as illustrated in FIG. 9 shows middle plate 191 extending from the inboard edge of base plate 193. Middle plate 191 is the same as middle plate 86 of bracket 50.

The described arrangement has been advanced by explanation and many modifications may be made without departing from the spirit and scope of the invention which includes every novel feature and novel combination of features herein disclosed.

Those skilled in the art will appreciate that the invention described herein is susceptible to variations and modifications other than those specifically described. It is understood that the invention includes all such variations and modifications which fall within the spirit and scope.

1. A connector for use in connecting a first building member to a second member to form a building structure, the connector comprising a first part for engaging with the first building member to locate the connector in use with respect to the first building member, and a second part for retaining the second building member in position with respect to the first building member, wherein the second part of the connector has a first portion and a second portion, the first and second portions being arranged with respect to each other such that the first portion extends in a direction in alignment with the direction of extension of the first part of the connector, the first portion for locating the connector with respect to the second building member, and the second portion of the second part of the connector extending out of alignment with the first part for retaining the second building member in position with respect to the first building member, so that at least one axis of the second building member extends in alignment with at least one axis of the first building member, wherein the first and second building members are connected together by the connector.

2. A connector for connecting a first building member to a second building member to form a building structure from the first and second building members, the connector comprising a first part having a first void for receiving the first building member therethrough, the first void being defined at least in part by at least one extension member, the extension member for contacting the first building member in use of the connector when the first building member is received in the void, wherein the first part of the connector is for locating the connector with respect to the first building member, and a second part for retaining the second building member in position with respect to the first building member to form a part of the building structure, the second part having a holder for retaining the second building member therein to retain the second building member with respect to the first building member.

3. A first bracket and a second bracket forming a pair of brackets for joining building panels to respective support posts to form a fence, each of the first and second brackets having a loop portion for receiving therethrough a respective post for locating the bracket at a selected position on the post, and each of the first and second brackets having a panel receiving portion for receiving part of a panel to connect the panel to the post, wherein the loop portion of one of the pair of brackets extends from the receiving portion at a first orientation, such that the receiving portion and loop portion are in stepped relationship with each other, and wherein the loop portion of the other of the pair of brackets extends from the receiving portion at a second orientation such that the receiving portion and loop portion are substantially in alignment with each other and wherein the loop portions of the two brackets are complementary to each other.

4. A connector according to claim 1 in which the connector is a bracket, wherein one form of the bracket has a stepped configuration in which the outwardly extending portion is in a stepped relationship or out of the plane of the retaining portion.

5. A connector according to claim 1 in which the connector is a bracket, wherein one form of the bracket is an aligned configuration in which the outwardly extending portion is aligned with or is in substantially the same plan as the retaining portion.

6. A connector according to claim 4 in which the outwardly extending portion of the bracket is in the form of a loop and the retaining portion is in the form of a tray portion.

7. A connector according to claim 1 in which the first building member is a support member in the form of a post and the second building member is an infill member in the form of a panel, the panel extending between two spaced apart posts, wherein the post is a steel post, a corrosion resistant steel post, a treated steel post, a coated steel post, a painted steel post, a colour bond steel post, a galvanised steel post, a zincalum steel post or a post having a protective coating, and the building panel is a light weight building panel made from autoclaved aerated concrete (AAC) panel.

8. A connector according to claim 7 in which the AAC panel is a reinforced AAC panel having a reinforcing mesh embedded within the panel.

9. A connector according to claim 1 in which the one part of the bracket is a loop arrangement defining an internal void, gap, space, cavity formed by walls or wall sections extending from the bracket.

10. A connector according to claim 9 in which the shape of the loop corresponds generally to the shape of the post so that the post is received within the loop so as to secure the bracket to the post by the shape of the loop being matched to the profile of the post.

11. A connector according to claim 9 in which the loop is formed at least in part by a pair of arms arranged in end to end facing relationship to each other along one side of the loop.

12. A connector according to claim 1 in which the receiving portion or holding portion of the bracket is in the form of a tray for supporting the panel in use, wherein the tray includes a base plate, a bracket roof or top being able to be oriented in one orientation in which the base plate forms a lid of the tray whereas in another orientation the base plate forms a floor of the tray.

13. A connector according to claim 12 in which the tray further comprises a pair of spaced apart walls extending from opposite sides of the base plate wherein in one orientation the walls extend in a first direction from the base plate and in a second orientation the walls extend from the base plate in a second direction wherein the first and second directions are opposite directions to each other.

14. A connector according to claim 12 in which the bracket can be oriented so that the tray can face upwardly to support the panel received in the tray from underneath the panel or the tray can face downwardly to support the panel received in the tray from above the panel to prevent lateral movement of the panel in the direction out of the plane of the panel.

15. A connector according to claim 1 in which the bracket further comprises apertures in the form of fastening apertures for receiving therethrough fasteners for attaching the bracket to a post or to a panel or to the post and panel, wherein the apertures are located at different locations of different parts of the bracket for use in securing the fence wherein the apertures are arranged singly or in groups of two or more spaced apart apertures in different parts of the bracket.

16. A connector according to claim 1 wherein the bracket further includes an irregularity or discontinuity in the surface of one or more parts of the bracket wherein the irregularity or discontinuity is in the form of a projection or depression.

17. A connector according to claim 16 in which the projection is in the form of a bump, ridge, rib, boss, dimple or other outwardly directed irregularity or surface discontinuity.

18. A connector according to claim 16 in which the depression is in the form of a cavity, dimple, hollow, groove, rebate or other inwardly directed surface irregularity.

19. A connector according to claim 16 in which the location of the irregularity or discontinuity corresponds to the location of the head of a fastener for fastening the bracket to the post or panel or post and panel to receive the head of the fastener therein to enable the bracket to fit flat with the side or edge of the panel.

20. A connector according to claim 3 in which the loop of the bracket is formed by arms, wherein the width of the arms of the loop of the bracket is about half of the width of the walls or wings of the tray of the bracket so that when a first bracket having a stepped configuration and a second bracket having an aligned configuration are received on a post in abutting relationships to each other the arms of the first and of the second brackets overlie one another in abutting relationship about the post such that the combined width of the arms of the first and second brackets is substantially the same as the widths of the wall or wings of the loops of the first and second brackets so that the base plates of the first and second brackets are substantially coplanar to each other.
